(19) United States
(12) Patent Application Publication
(10) Pub. No.: US 2017/0315221 A1
(43) Pub. Date: Nov. 2, 2017

(54) TARGET RECOVERY IN MULTIPLE INPUT MULTIPLE OUTPUT (MIMO) RADAR SYSTEM

(71) Applicant: TECHNION RESEARCH & DEVELOPMENT FOUNDATION LTD., Haifa (IL)

(72) Inventors: David COHEN, Haifa (IL); Yonina C. ELDAR, Haifa (IL)

(21) Appl. No.: 15/582,819

(22) Filed: May 1, 2017

(30) Foreign Application Priority Data
May 1, 2016 (IL) 245366

(51) Int. Cl. G01S 13/02; G01S 7/288; H01Q 21/22

(52) U.S. Cl. CPC G01S 13/0209; H01Q 21/22; G01S 7/288; G01S 2007/2883

(57) ABSTRACT

A Multiple Input Multiple Output (MIMO) radar system and method of using it for target recovery are disclosed. The MIMO radar system comprises an array of distributed radiating elements configured to transmit signals towards a target scene, an array of distributed receiving elements configured to receive signals backscattered from the target scene, a sampling module configured to sample the signals received, and a hardware processor configured to recover from the samples position parameters of one or more targets. Range, direction and optionally velocity, are estimated via simultaneous 2D or 3D sparse matrix recovery, wherein all channels defined by transmitter-receiver pairs are processed together. The digital processing may be applied either in Nyquist or sub-Nyquist scheme, reducing the number of samples, transmit and/or receive antennas. The radar system is optionally further enhanced by cognitive transmission scheme where transmitted signals are distributed over a wide frequency range with vacancy bands left therein.

### CROSS-REFERENCE TO RELATED APPLICATION

This application claims the benefit of IL Application No. 245366 filed May 1, 2016, which is hereby incorporated by reference in its entirety without giving rise to disavowment.

### TECHNICAL FIELD

The present disclosure relates to object detection using reflection of transmitted radio waves in general, and to recovering target parameters with high precision using Multiple Input Multiple Output (MIMO) radar, in particular.

### BACKGROUND

Multiple Input Multiple Output (MIMO) radar, as generally discussed for example in: E. Fishler, A. Haimovich, R. Blum, D. Chizhik, L. Cimini, and R. Valenzuela, “MIMO radar: an idea whose time has come,” in IEEE Radar Conf. (RADARCON), 2004, pp. 71-78, hereby incorporated by reference in its entirety without giving rise to disavowment, is an emerging technology which presents significant potential for advancing state-of-the-art modern radar in terms of flexibility and performance, on the one hand, while posing new theoretical and practical challenges, on the other hand. This radar architecture combines multiple antenna elements both at the transmitter and receiver where each transmitter radiates a different waveform. Two main MIMO radar architectures are collocated MIMO in which the elements are close to each other, and multistatic MIMO where they are widely separated. General discussions of collocated MIMO and multistatic MIMO can be found respectively for example in: J. Li and P. Stoica, “MIMO radar with colocated antennas,” IEEE Signal Proc. Magazine, vol. 24, no. 5, pp. 106-114, 2007; and A. M. Haimovich, R. S. Blum, and L. J. Cimini, “MIMO radar with widely separated antennas,” IEEE Signal Proc. Magazine, vol. 25, no. 1, pp. 116-129, 2008, both of which are hereby incorporated by reference in their entirety without giving rise to disavowment.

Collocated MIMO radar systems exploit the waveform diversity, based on mutual orthogonality of the transmitted signals. This generates a virtual array induced by the phase differences between transmit and receive antennas. Such systems thus achieve higher resolution than their phased-array counterparts with the same number of elements, contributing to MIMO popularity. This increased performance comes at the price of higher complexity in the transmitters and receivers design. MIMO radar systems belong to the family of array radars, which allow to recover simultaneously the targets' range, Doppler and azimuth. This three-dimensional recovery results in high digital processing complexity. One of the main challenges of MIMO radar is thus coping with complicated systems in terms of cost, high computational load and complex implementation.

### BRIEF SUMMARY

One exemplary embodiment of the disclosed subject matter is a radar system comprising: a transmitter comprising an array of distributed radiating elements configured to transmit a plurality of signals towards a target scene; a receiver comprising an array of distributed receiving elements configured to receive signals backscattered from the target scene; a sampling module configured to sample the signals received by said receiver at sub-Nyquist rate to obtain a set of Fourier coefficients for each signal of the plurality of signals transmitted; a hardware processor configured to recover from the set of Fourier coefficients at least one position parameter for one or more targets within the target scene.

Another exemplary embodiment of the disclosed subject matter is a radar system comprising: a transmitter comprising an array of distributed radiating elements configured to transmit a plurality of signals towards a target scene, wherein the plurality of signals having carrier frequencies that are distributed over a wide band and waveforms having a narrow bandwidth for each single transmission with respect to an effective sampling rate thereof, wherein the plurality of signals transmitted, when accumulated, do not occupy an entire frequency range of the wide band over which they are distributed; a receiver comprising an array of distributed receiving elements configured to receive signals backscattered from the target scene; a sampling module configured to sample the signals received by said receiver; and a hardware processor configured to recover from samples sampled by said sampling module at least one position parameter for one or more targets within the target scene.

Yet another exemplary embodiment of the disclosed subject matter is a method comprising: obtaining a set of samples of a plurality of signals transmitted from an array of distributed radiating elements towards a target scene and received at an array of distributed receiving elements as reflected back from the target scene; and estimating gain and position parameters of at least one target contained in the target scene, wherein said estimating comprises applying a process for solving a set of matrix equations to recover a sparse matrix, wherein input for the process comprises: an observation matrix of samples from the set that correspond to respective signals received at each of the receiving elements for each of the signals transmitted, and measurement matrices of grid coordinates conforming to hypothesized position parameters whereby a dictionary of possible values for each of the position parameters is defined; wherein estimated gain and position parameters for each of the at least one target are provided by respective values and indices of non-zero entries of the sparse matrix recovered by the process; wherein the process is adapted for simultaneously processing of all channels defined by pairs of transmitters and receivers from each of the arrays.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1B show a schematic illustration of a collocated MIMO array structure and corresponding virtual array, in accordance with some exemplary embodiments of the disclosed subject matter;

FIG. 2 shows a schematic illustration of a MIMO array configuration, in accordance with some exemplary embodiments of the disclosed subject matter;

FIGS. 3A-3B shows a schematic illustration of a collocated MIMO array structure and corresponding spatially thinned array, in accordance with some exemplary embodiments of the disclosed subject matter;

FIGS. 4A-4B show a schematic illustration of distribution and bandwidth of carrier frequencies and waveforms in an FDMA framework and corresponding cognitive transmissions, in accordance with some exemplary embodiments of the disclosed subject matter;

FIGS. 5A-5B show schematic illustrations of 2D and 3D target recovery in predefined grid, in accordance with some exemplary embodiments of the disclosed subject matter;

FIG. 6 shows a block diagram of an apparatus, in accordance with some exemplary embodiments of the disclosed subject matter; and

FIG. 7 shows a flowchart diagram of a method, in accordance with some exemplary embodiments of the disclosed subject matter.

### DETAILED DESCRIPTION

Several works investigate Compressed Sensing (CS) recovery for MIMO architectures, assuming a sparse target scene, where the ranges, Dopplers and azimuths lie on a predefined grid. One such approach is discussed in T. Strohmer and H. Wang, “Sparse MIMO radar with random sensor arrays and Kerdock codes,” IEEE Int. Conf. on Sampling Theory and Applications (SAMPTA), pp. 517-520, 2013, hereby incorporated by reference in its entirety without giving rise to disavowment, where Kerdock codes are used in order to ensure waveform orthogonality, and the antenna locations are chosen at random. Another example is disclosed in T. Strohmer and B. Friedlander, “Analysis of sparse MIMO radar,” Applied and Computational Harmonic Analysis, pp. 361-388, 2014, hereby incorporated by reference in its entirety without giving rise to disavowment, where the transmissions are random signals and a virtual Uniform Linear Array (ULA) structure is adopted. A detailed discussion of CS in general is presented in Y. C. Eldar and G. Kutyniok, “Compressed Sensing: Theory and Applications.” Cambridge University Press, 2012, hereby incorporated by reference in its entirety without giving rise to disavowment. CS reconstruction is traditionally proposed to reduce the number of measurements required for the recovery of a sparse signal in some domain. However, in the works above, this framework is not used to reduce the spatial or time complexity, namely the number of antennas and samples, but is rather focused on mathematical guarantees of CS recovery in the presence of noise. To that end, the authors use a dictionary that accounts for every combination of azimuth, range and Doppler frequency on the grid and the targets' parameters are recovered by matching the received signal with dictionary atoms. The processing efficiency is thus penalized by a very large dictionary that contains every parameters combination.

Several works have then considered reducing the number of antennas or the number of samples per receiver without degrading the resolution. The partial problem of azimuth recovery of targets all in the same range-Doppler bin is investigated in M. Rossi, A. M. Haimovich, and Y. C. Eldar, “Spatial compressive sensing for MIMO radar,” IEEE Trans. on Signal Proc., vol. 62, no. 2, pp. 419-430, 2014, hereby incorporated by reference in its entirety without giving rise to disavowment. There, spatial compression is performed, where the number of antennas is reduced while preserving the azimuth resolution. Beamforming is applied on the time domain samples obtained from the thinned array at the Nyquist rate and the azimuths are recovered using CS techniques. In several other disclosures, a time compression approach is adopted where the Nyquist samples are compressed in each antenna before being forwarded to the central unit. Exemplary investigations of this approach include: Y. Yu, A. P. Petropulu, and H. V. Poor, “MIMO radar using compressive sampling,” IEEE Journal of Selected Topics in Signal Proc., vol. 4, no. 1, pp. 146-163, 2010, hereby incorporated by reference in its entirety without giving rise to disavowment, which exploits sparsity and uses CS recovery methods; as well as in: D. S. Kalogerias and A. P. Petropulu, “Matrix completion in collocated MIMO radar: Recoverability, bounds & theoretical guarantees,” IEEE Trans. on Signal Proc., vol. 62, no. 2, pp. 309-321, 2014; and S. Sun, W. U. Bajwa, and A. P. Petropulu, “MIMO-MC radar: A MIMO radar approach based on matrix completion,” CoRR, vol. abs/1409.3954, 2014, [Online] available: http://arxiv.org/abs/1409.3954, hereby incorporated by reference in their entirety without giving rise to disavowment, both of which apply matrix completion techniques to recover the missing samples, prior to reconstruction of azimuth-Doppler in the former or range-azimuth-Doppler in the latter, respectively. However, the authors do not address sampling and processing rate reduction since the compression is performed in the digital domain and the missing samples are reconstructed before recovering the targets' parameters.

In all the above works, the recovery is performed in the time domain and requires Nyquist rate samples in each antenna. To reduce the sampling rate while preserving the resolution, the authors in: O. Bar-Ilan and Y. C. Eldar, “Sub-Nyquist radar via Doppler focusing,” IEEE Trans. on Signal Proc., vol. 62, no. 7, pp. 1796-1811, 2014, hereby incorporated by reference in its entirety without giving rise to disavowment, consider frequency domain recovery. Similar ideas have been also used in the context of ultrasound imaging, as discussed e.g. in: N. Wagner, Y. C. Eldar, and Z. Friedman, “Compressed beamforming in ultrasound imaging,” IEEE Trans. Signal Process., vol. 60, no. 9, pp. 4643-4657, 2012; and T. Chernyakova and Y. C. Eldar, “Fourier-domain beamforming: the path to compressed ultrasound imaging,” IEEE Trans. Ultrasonics, Ferroelectrics and Frequency Control, vol. 61, pp. 1252-1267, 2014, hereby incorporated by reference in their entirety without giving rise to disavowment. The afore-mentioned work demonstrates low-rate range-Doppler recovery in the context of monostatic radar, including sub-Nyquist acquisition and low-rate digital processing. Low-rate data acquisition is based on the ideas of Xampling, which consists of an analog-to-digital converter (ADC) performing analog prefiltering of the signal before taking point-wise samples at low rate, such as discussed in: M. Mishali, Y. C. Eldar, O. Dounaevsky, and E. Shoshan, “Xampling: Analog to digital at sub-Nyquist rates,” IET circuits, devices & systems, vol. 5, no. 1, pp. 8-20, 2011; and Y. C. Eldar, “Sampling Theory: Beyond Bandlimited Systems.” Cambridge University Press, 2015, hereby incorporated by reference in their entirety without giving rise to disavowment. In accordance with this approach, the samples are a sub-set of digitally transformed Fourier coefficients of the received signal, that contain the information needed to recover the desired signal parameters using CS algorithms. A practical analog front-end implementing such a sampling scheme in the context of radar is presented in E. Baransky, G. Itzhak, I. Shmuel, N. Wagner, E. Shoshan, and Y. C. Eldar, “A sub-Nyquist radar prototype: Hardware and applications,” IEEE Trans. Aerosp. and Elect. Syst., vol. 50, pp. 809-822, April 2014, hereby incorporated by reference in its entirety without giving rise to disavowment. To recover the targets' range-Doppler from the sub-Nyquist samples, the authors introduce Doppler focusing, which is a coherent superposition of time shifted and modulated pulses. For any Doppler frequency, the received signals from different pulses are combined so that targets with corresponding Doppler frequencies come together in phase. This method improves the signal to noise ratio (SNR) by a factor of the number of pulses.

One technical problem dealt with by the disclosed subject matter is to recover, with high precision, positional parameters of one or more targets at a scene of interest, such as azimuth, range and Doppler frequency, using MIMO radar. In this context, one major drawback of common approaches is an existence of a tradeoff between range and azimuth resolution, i.e. targets located either in a same direction with slightly differing distances from the antenna array, or at a same range with minor difference in angle, cannot be effectively discerned as separated from each other, where ameliorating the situation in one of these scenarios worsens it in the other, and vice versa. As would be appreciated by a person skilled in the art, overcoming this tradeoff may be key to achieving enhanced accuracy in object detection and pinpointing thereof.

Another technical problem dealt with by the disclosed subject matter is to achieve reduction in the number of deployed antennas of MIMO radar configurations, and the number of samples per each receiver thereof, without degrading the time and spatial resolutions. As would be appreciated by a person skilled in the art, achieving high azimuth resolution requires a wide radar aperture, i.e. a large number of transmit and receive antennas. In addition, the digital processing is performed on samples of the received signal, from each transmitter to each receiver, at its Nyquist rate, which can be prohibitively large when high range resolution is needed.

Yet another technical problem dealt with by the disclosed subject matter is to provide MIMO radar methods and systems allowing for high bandwidth signal transmission on the one hand, as required in order to achieve high range resolution, while maintaining narrowband waveforms on the other hand, as needed for enabling high azimuth resolution as well. In MIMO radar, two of the most popular approaches to ensure waveform orthogonality are Code Division Multiple Access (CDMA) and Frequency Division Multiple Access (FDMA). Although the narrowband assumption, which is crucial for MIMO processing, can hardly be applied to CDMA waveforms, it is typically preferred. This is due to two essential drawbacks presented by FDMA: range-azimuth coupling and limited range resolution to a single waveform's bandwidth.

One technical solution is to obtain samples at a sub-Nyquist rate. In some exemplary embodiments, sub-Nyquist sampling methods (referred to as Xampling) may be applied to MIMO configurations in order to break the link between the aperture and the number of antennas, which defines the spatial or azimuth resolution. In some exemplary embodiments, such approach may utilize the Xampling framework to break the link between monostatic radar signal bandwidth and sampling rate, which defines the time or range resolution, whereby overcoming the rate bottleneck. Such approach may be used for range-azimuth recovery, azimuth-range-Doppler recovery, or the like. In some exemplary embodiments, Xampling may be applied both in space (antennas deployment) and in time (sampling scheme) in order to simultaneously reduce the required number of antennas and samples per receiver, without degrading the time and spatial resolution. In particular, spatial and time compression may be performed while keeping the same resolution induced by Nyquist rate samples obtained from a full virtual array with low computational cost. In some exemplary embodiments, the “Xamples”, or compressed samples, both in time and space, may be expressed in terms of the targets' unknown parameters, namely range, azimuth and Doppler, to be recovered from the sub-Nyquist samples.

Another technical solution is to perform simultaneous recovery of all targets' parameters wherein all channels between transmitters and receivers' pairs of the MIMO arrays are coherently processed together. In some exemplary embodiments, reconstruction algorithms extending sparse matrix recovery techniques, such as Orthogonal Matching Pursuit (OMP), Fast Iterative Shrinkage-Thresholding Algorithm (FISTA), or likewise recovery algorithms, may be employed in order to solve a system of matrix equations, similarly to matrix sketching. It will be appreciated however that, in contrast to matrix sketching where only one matrix equation is considered, formulation of the recovery in the context of MIMO radar may be more complex as a result of coupling between the parameters, as well as involve simultaneous processing of several matrix equations, one per transmitter, to jointly recover the targets' range, azimuth and optionally Doppler parameters. It will be appreciated that, while the disclosed subject matter may be useful for CS recovery, e.g. when the Xampling framework is utilized, it is not, however, meant to be limited in such manner, but rather it may be applied also in a Nyquist framework, where Nyquist rate sampling and full array of transmit and receive antennas are employed. It will further be appreciated that simultaneous sparse matrix recovery processing in accordance with the disclosed subject matter overcomes these two drawbacks of standard FDMA, namely the range-azimuth coupling and limited range resolution, thereby allowing adoption of FDMA framework for the transmitted signals. This approach, as opposed to CDMA, allows to legitimately assume narrowband waveforms, which is key to azimuth resolution. This thus reconciles the trade-off between azimuth and range resolution. The disclosed subject matter is not limited, however, to FDMA framework only, and may be adapted to CDMA frameworks as well. For example, either time or spatial compression under the Xampling framework in accordance with the disclosed subject matter may be used also in CDMA context.

Yet another technical solution is to adopt an FDMA framework wherein transmitters are assigned with carrier frequencies and waveforms that are distributed over a wide band without occupying the entire frequency range thereof, while received signals are sampled at a rate in accordance with an effective bandwidth of a single transmission. In this manner, high range resolution is maintained due to the high overall bandwidth of the accumulated transmissions. It will be appreciated that the transmission in accordance with this scheme may be cognitive. In some exemplary embodiments, the frequency bands left vacant can be exploited to communication.

One technical effect of utilizing the disclosed subject matter is to provide a MIMO radar system with low rate sampling and digital processing. The unknown targets parameters may be recovered from sub-Nyquist samples obtained using Xampling. Both sampling and digital processing may be performed at a low rate.

Another technical effect of utilizing the disclosed subject matter is to provide MIMO radar with reduced number of antennas. In some exemplary embodiments, beamforming is performed on the Xamples obtained from a reduced number of transmit and receive antennas while keeping a fixed aperture.

Yet another technical effect of utilizing the disclosed subject matter is to allow for scaling with problem size. In some exemplary embodiments, the three dimensions (range, azimuth and Doppler) may be separated by adapting to matrix form, with several matrix system equations. This avoids the use of a large CS dictionary, where each column corresponds to a range-azimuth-Doppler hypothesis.

Yet another technical effect of utilizing the disclosed subject matter is to achieve maximal bandwidth exploitation. In some exemplary embodiments, an enhanced version of a (sub-Nyquist) MIMO radar may be employed, which exploits the frequency bands left vacant by spatial compression for additional transmissions, whereby increasing the detection performance while preserving the total bandwidth.

Yet another technical effect of utilizing the disclosed subject matter is to reconcile azimuth and range resolution trade-off. In some exemplary embodiments, FDMA waveforms may be employed to simultaneously allow for narrowband single transmissions for high azimuth resolution and large total bandwidth for high range resolution.

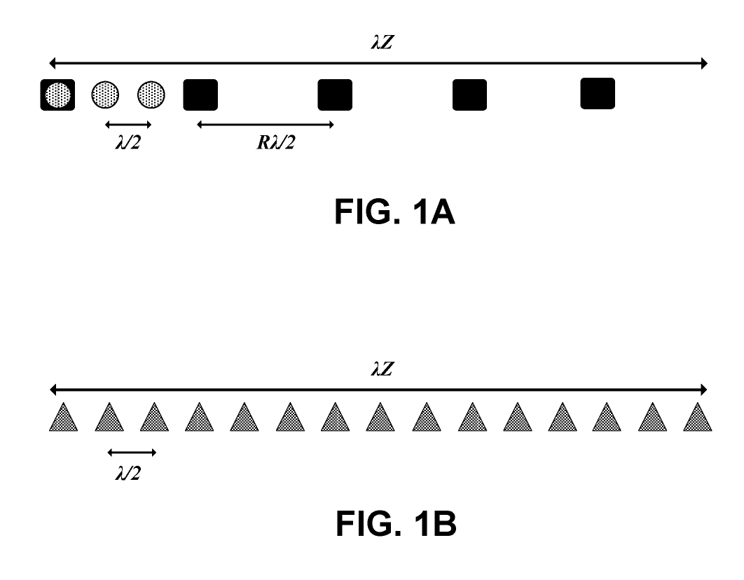

Referring now to FIGS. 1A-1B showing a schematic illustration of a collocated MIMO array structure and corresponding virtual array, in accordance with some exemplary embodiments of the disclosed subject matter.

A traditional approach to collocated MIMO adopts a virtual ULA structure, where R receivers, spaced by λ/2 and T transmitters, spaced by R λ/2 (or vice versa), form two ULAs, where, λ is the signal wavelength. Coherent processing of the resulting TR channels generates a virtual array equivalent to a phased array with TR

$$\frac{λ}{2}$$

-spaced receivers and normalized aperture

$$Z = \frac{TR}{2} .$$

FIG. 1A illustrates a standard array structure for R=3 and T=5, wherein receivers are denoted by bright circles and transmitters are denoted by dark squares. The corresponding virtual array is illustrated in FIG. 1B.

Each transmitting antenna may send P pulses, such that the m-th transmitted signal may be given by

sₘ(t)=Σₚ₌₀^{P-1}hₘ(t−pτ)e^{j2πf}^{_{c}}^{t}, 0≦t≦PT (1)

where hₘ(t), 0≦m≦T−1 are narrowband and orthogonal pulses with bandwidth Bₕ, modulated with carrier frequency f_{c}. The Coherent Processing Interval (CPI) may be equal to Pτ, where τ denotes the Pulse Repetition Interval (PRI). For convenience, it may be assumed that f_{c}τ is an integer, so that the delay e^{-j2πf}^{_{c}}^{τp} is canceled in the modulation for 0≦p≦P−1. The pulse time support is denoted by Tₚ, with 0<Tₚ<τ.

MIMO radar architectures may impose several requirements on the transmitted waveform family. Besides traditional demands from radar waveforms such as low sidelobes, MIMO transmit antennas may rely on orthogonal waveforms. In addition, to avoid cross talk between the T signals and form TR channels, the orthogonality condition should be invariant to time shifts, that is ∫_{-∞}^{∞}sᵢ(t)sⱼ*(t−τ₀)dt=δ(i−j), for i,jε[0, M−1] and for all τ₀. This property implies that the orthogonal signals cannot overlap in frequency, leading to FDMA. Alternatively, time invariant orthogonality can be approximately achieved using CDMA.

Both FDMA and CDMA follow the general model:

hₘ(t)=Σᵤ₌₁^{N}^{_{c}}wₘᵤe^{j2πf}^{ₘᵤ}^{t}^{ᵥ}^{(t-uδ}^{ₜ}⁾ (2)

where each pulse is decomposed into N_{c} time slots with duration δₜ. Here, ν(t) denotes the elementary waveform, wₘᵤ represents the code and fₘᵤ the frequency for the m-th transmission and u-th time slot. The general expression (2) allows to analyze at the same time different waveforms families. In particular, in CDMA, the orthogonality is achieved by the code {wₘᵤ}ᵤ₌^{N}^{_{c}} and fₘᵤ=0 for all 1≦u≦Nc. In FDMA, N_{c}=1, wₘᵤ=1 and δₜ=0. The center frequencies fₘᵤ=fₘ are chosen in

$$[ - \frac{{TB}_{h}}{2} , \frac{{TB}_{h}}{2} ]$$

so that the intervals

$$[ {f}_{m} - \frac{{B}_{h}}{2} , {f}_{m} + \frac{{B}_{h}}{2} ]$$

do not overlap. For simplicity of notation, {hₘ(t)}ₘ₌₀^{T-1} can be considered as frequency-shifted versions of a low-pass pulse ν(t)=h₀(t) whose Fourier transform H₀(ω) has bandwidth Bₕ, such that

Hₘ(ω)=H₀(ω−2πfₘ). (3)

In the present disclosure, a unified notation for the total bandwidth Bₜₒₜ=TBₕ for FDMA and Bₜₒₜ=Bₕ for CDMA is adopted.

In accordance with the disclosed subject matter, L non-fluctuating point-targets, according to the Swerling-0 model, may be considered. Each target may be identified by its parameters: radar cross section (RCS) \tilde{α}ₗ, distance between the target and the array origin or range Rₗ, velocity νₗ and azimuth angle relative to the array θₗ. In the present disclosure, RCS may be also referred to as gain. The disclosed subject matter may be utilized for the goal of recovering the targets' delay

$${τ}_{l} = \frac{2 {R}_{l}}{c} ,$$

azimuth sine θₗ=sin(θₗ) and Doppler shift

$${f}_{l}^{D} = \frac{2 {v}_{l}}{c} {f}_{c}$$

from the received signals. In the present disclosure, the terms range and delay may be used interchangeably, as well as azimuth angle and sine, and velocity and Doppler frequency, respectively.

The following assumptions may be adopted on the array structure and targets' location and motion, leading to a simplified expression for the received signal:
A1. Collocated array—target RCS \tilde{α}ₗ and θₗ are constant over the array;
A2. Far targets—target-radar distance is large compared to the distance change during the CPI, which allows for constant \tilde{α}ₗ,

$${v}_{l} P τ ≪ \frac{c {τ}_{l}}{2} \qquad ( 4 )$$

A3. Slow targets—low target velocity allows for constant τₗ during the CPI,

$$\frac{2 {v}_{l} P τ}{c} ≪ \frac{1}{{B}_{tot}} \qquad ( 5 )$$

and constant Doppler phase during pulse time Tₚ,

fₗ^{D}Tₚ<<1. (6)
A4. Low acceleration—target velocity νₗ remains approximately constant during the CPI, allowing for constant Doppler shift fₗ^{D},

$${\dot{v}}_{l} P τ ≪ \frac{c}{2 {f}_{c } P τ} . \qquad ( 7 )$$

A5. Narrowband waveform—small aperture allows τₗ to be constant over the channels,

$$\frac{2 Z λ}{c} ≪ \frac{1}{{B}_{tot}} . \qquad ( 8 )$$

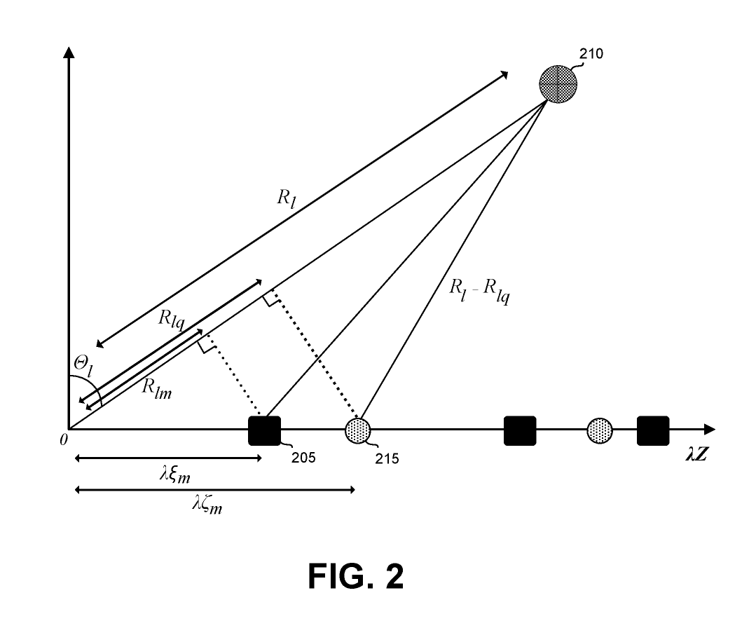

Referring now to FIG. 2 showing a schematic illustration of a MIMO array configuration, in accordance with some exemplary embodiments of the disclosed subject matter.

FIG. 2 illustrates a MIMO array geometry, where receivers are denoted by bright circles and transmitters are denoted by dark squares, similarly as in FIGS. 1A-1B. The transmitted pulses are reflected by the targets and collected at the receive antennas. For example, as illustrated in FIG. 2, a signal may be transmitted by a Transmitter 205 and received by a Receiver 215, as reflected by a Target 210. Under assumptions A1, A2 and A4, the received signal \tilde{x}_{q}(t) at the q-th antenna is then a sum of time-delayed, scaled replica of the transmitted signals:

$${\tilde{x}}_{q} ( t ) = {\sum }_{m = 0}^{T - 1} {\sum }_{l = 1}^{L} {\tilde{α}}_{l} {s}_{m} ( \frac{c - {v}_{l}}{c + {v}_{l}} ( t - \frac{{R}_{l , mq}}{c + {v}_{l}} ) ) , \qquad ( 9 )$$

where R_{l,mq}=2Rₗ−(Rₗₘ+R_{lq}), with Rₗₘ=λξₘθₗ and R_{lq}=λζ_{q}θₗ accounting for the array geometry, as illustrated in FIG. 2. The received signal expression may be further simplified using the above assumptions. For example, starting with the envelope hₘ(t) and considering the p-th frame and the l-th target, from c±ν₁≈c and neglecting the term

$$\frac{2 {v}_{l}}{c}$$

from A3 (5), one may obtain

$${h}_{m} ( \frac{c - {v}_{l}}{c + {v}_{l}} ( t - \frac{{R}_{l , mq}}{c + {v}_{l}} ) - p τ ) = {h}_{m} ( t - p τ - {τ}_{l , mq} ) . \qquad ( 10 )$$

$${τ}_{l} = \frac{2 {R}_{l}}{c}$$

In the present disclosure, τ_{l,mq}=τ₁−η_{mq}θₗ where denotes me target delay and

$${η}_{mq} = ( {ξ}_{m} + {ζ}_{q} ) \frac{λ}{c}$$

follows from the respective locations between transmitter and receiver. The modulation term of sₘ(t) may then be added, and again using c±ν₁≈c, the remaining term may be given by

hₘ(t−pτ−τ_{l,mq})e^{j2π(f}^{_{c}}^{+f}^{ₗ}^{^{D}}^{)(t-τ}^{_{l,mq}}⁾. (11)

After demodulation to baseband and using A3 (6), one may further simplify (11) to

hₘ(t−pτ−τ_{l,mq})e^{-j2πf}^{_{c}}^{τ}^{ₗ}e^{j2πf}^{_{c}}^{η}^{_{mq}}^{θ}^{ₗ}e^{j2πf}^{ₗ}^{^{D}}^{_{pτ}}. (12)

The three phase terms in (12) corresponds to the target delay, azimuth and Doppler frequency, respectively. Last, from the narrowband assumption on hₘ(t) and A5 (8), the delay term η_{mq}θₗ, that stems from the array geometry, may be neglected in the envelope, which may become

hₘ(t−pτ−τₗ). (13)

Substituting (13) in (12), the received signal at the q-th antenna after demodulation to baseband may be given by

x_{q}(t)=Σₚ₌₀^{P-1}Σₘ₌₀^{M-1}Σₗ₌₁^{L}αₗhₘ(t−pτ−τ₁)e^{j2πf}^{_{c}}^{η}^{_{mq}}^{θ}^{ₗ}e^{j2πf}^{ₗ}^{^{D}}^{_{pτ}}, (14)

where αₗ=\tilde{α}ₗe^{-2πf}^{_{c}}^{τ}^{ₗ}. In CDMA, the narrowband assumption on the waveforms hₘ(t) may limit the total bandwidth Bₜₒₜ=Bₕ, leading to a trade-off between time and spatial resolution. In accordance with the disclosed subject matter, in FDMA this assumption can be relaxed with respect to the single bandwidth Bₕ, rather than Bₜₒₜ=TBₕ.

Collocated MIMO radar processing may include the following stages:
1) Sampling: at each receiver, the signal x_{q}(t) may be sampled at its Nyquist rate Bₜₒₜ.
2) Matched filter: the sampled signal may be convolved with a sampled version of hₘ(t), for 0≦m≦T−1. The time resolution attained in this step may be 1/Bₕ.
3) Beamforming: correlations between the observation vectors from the previous step and steering vectors corresponding to each azimuth on the grid defined by the array aperture may be computed. The spatial resolution attained in this step may be 2/TR. In FDMA, this step may lead to range-azimuth coupling.
4) Doppler detection: correlations between the resulting vectors and Doppler vectors, with Doppler frequencies lying on the grid defined by the number of pulses, may be computed. The Doppler resolution may be 1/Pτ.
5) Peak detection: a heuristic detection process may be performed on the resulting range-azimuth-Doppler map. For example, the detection can follow a threshold approach or select the L strongest points of the map, if the number of targets L is known.

In standard processing, the range resolution may thus be governed by the signal bandwidth Bₕ. The azimuth resolution may depend on the array aperture and given by 2/TR. Therefore, higher resolution in range and azimuth may require higher sampling rate and more antennas. The total number of samples to process, NTRP, where N=τBₕ, can then become prohibitively high. In order to break the link between time resolution and sampling rate on the one hand, and spatial resolution and number of antennas on the other hand, in accordance with the disclosed subject matter the Xampling framework may be applied to time (sampling scheme), space (antennas deployment), or both. The disclosed subject matter may be utilized for the goal of estimating the targets' range, azimuth and velocities, i.e. τₗ, θₗ and fₗ^{D} in (14), optionally while reducing the number of samples, transmit and/or receive antennas, or any of these combined.

In some exemplary embodiments, an FDMA approach may be adopted, in order to exploit the narrowband property of the transmitted waveforms. Classic FDMA presents two main drawbacks. First, due to the linear relationship between the carrier frequency and the index of antenna element, a strong range-azimuth coupling occurs. To resolve this aliasing issue, one approach uses random carrier frequencies, which creates high sidelobe level. This can be mitigated by increasing the number of transmit antennas. The second drawback of FDMA is that the range resolution is limited to a single waveform's bandwidth, namely Bₕ, rather than the overall transmit bandwidth Bₜₒₜ=TBₕ. These two drawbacks may be overcome utilizing the disclosed subject matter. First, to resolve the coupling issue, the antennas may be randomly distributed, while keeping the carrier frequencies on a grid with spacing Bₕ. Second, by coherently processing all the channels together, a range resolution of Bₜₒₜ=TBₕ may be achieved. This way, the overall received bandwidth that governs the range resolution may be exploited, while maintaining the narrowband assumption for each channel, which may be key to the azimuth resolution. It will be appreciated that the FDMA approach in accordance with the disclosed subject matter may be applied both in Nyquist and sub-Nyquist regimes, in time and space.

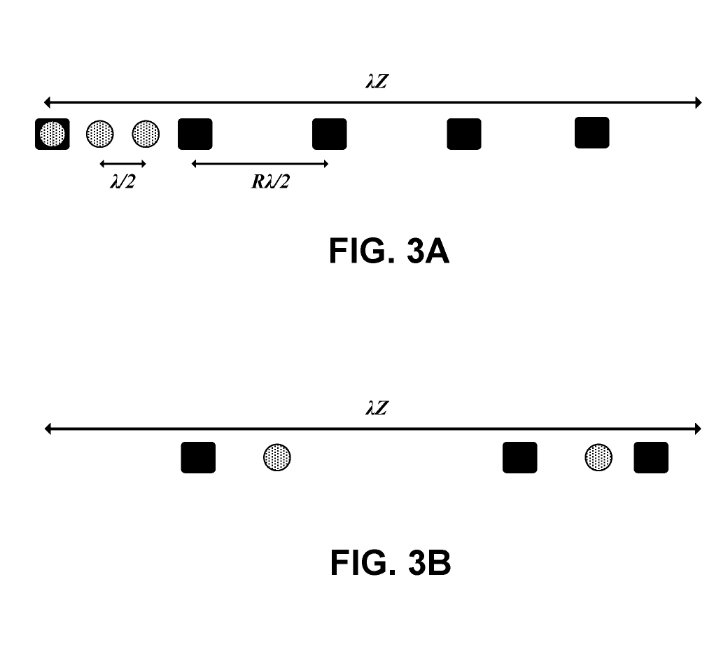

Referring now to FIGS. 3A-3B showing a schematic illustration of a collocated MIMO array structure and corresponding spatially thinned array, in accordance with some exemplary embodiments of the disclosed subject matter.

In some exemplary embodiments, a collocated MIMO radar system may comprise M<T transmit antennas and Q<R receive antennas, whose locations may be chosen uniformly at random within the aperture of the virtual array such as described above with reference to FIGS. 1A-1B, that is {ξₘ}ₘ₌₀^{M-1}˜ [symbol] [0,Z] and {ζ_{q}}_{q=0}^{Q-1}˜ [symbol] [0,Z], respectively. It will be appreciated that, in principle, the antenna locations can be chosen on the ULAs' grid. However, this configuration may be less robust to range-azimuth ambiguity and lead to coupling between these parameters in the presence of noise. FIG. 3A illustrates a standard array structure for R=3 and T=5, similarly as in FIG. 1A. The spatially thinned array structure is illustrated in FIG. 3B, for Q=2 and M=3. It will be appreciated, however, that the disclosed subject matter is not limited to random arrays and may be adapted to additional array structures.

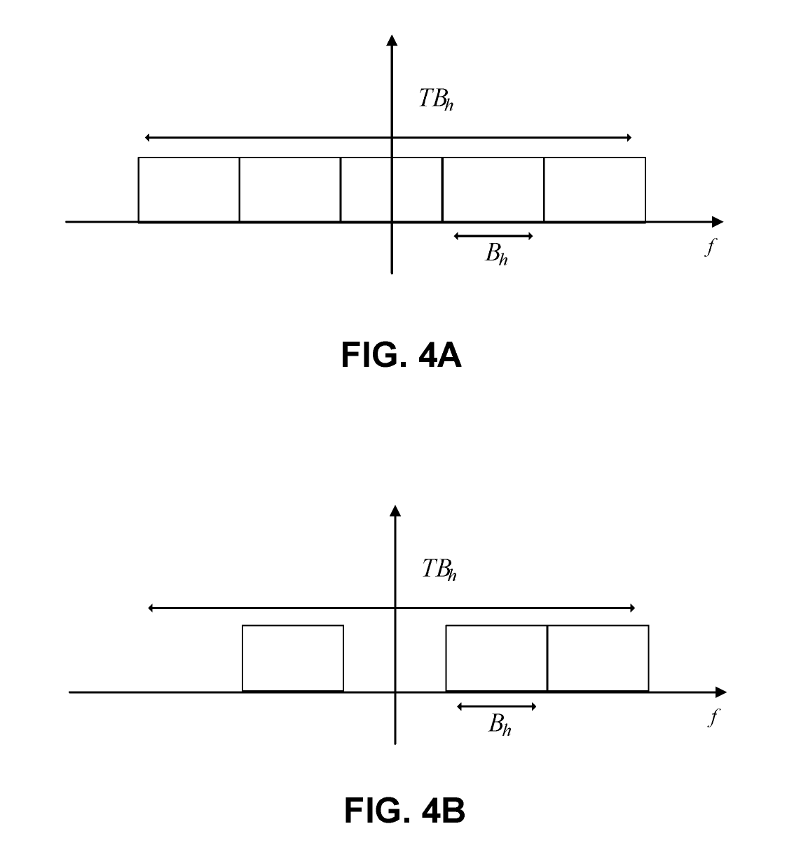

Referring now to FIGS. 4A-4B showing a schematic illustration of distribution and bandwidth of carrier frequencies and waveforms in an FDMA framework and corresponding cognitive transmissions, in accordance with some exemplary embodiments of the disclosed subject matter.

In some exemplary embodiments, an FDMA framework may be adopted. The transmitted signals are illustrated in FIGS. 4A-4B in the frequency domain. FIG. 4A shows a standard FDMA transmission with single waveform bandwidth Bₕ and total bandwidth Bₜₒₜ=TBₕ for T=5. FIG. 4B shows a corresponding cognitive transmission with same total bandwidth where only M<T of the available frequency bands are used for M=3. It will be appreciated that, while in FIGS. 4A-4B the waveforms are exemplified as rectangular, where FIG. 4B illustrates vacant frequency bands in a skipping pattern, the disclosed subject matter is not limited to a particular frequency distribution or waveform.

In some exemplary embodiments, the strict neglect of the delay term in the transition from (12) to (13) may be softened utilizing the disclosed subject matter. By only removing η_{mq}θₗ from the envelope h₀(t), that stems from the array geometry, (13) may then become

hₘ(t−pτ−τₗ)e^{j2πf}^{ₘ}^{η}^{_{mq}}^{θ}^{ₗ}. (15)

In some exemplary embodiments, the restrictive assumption A5 (8) may be relaxed to

$$\frac{2 Z λ}{c} ≪ \frac{1}{{B}_{h}} .$$

It will be appreciated that in CDMA, (8) leads to a trade-off between azimuth and range resolution, by requiring either small aperture or small total bandwidth Bₜₒₜ, respectively. In accordance with the disclosed subject matter, using the FDMA framework and less rigid approximation (15), only the single bandwidth Bₕ may need to be narrow, rather than the total bandwidth Bₜₒₜ, eliminating the trade-off between range and azimuth resolution. The received signal at the q-th antenna after demodulation to baseband may in turn be given by

x_{q}(t)=Σₚ₌₀^{P-1}Σₘ₌₀^{M-1}Σₗ₌₁^{L}αₗhₘ(t−pτ−τ₁)e^{j2πβ}^{_{mq}}^{θ}^{ₗ}e^{j2πf}^{ₗ}^{^{D}}^{_{pτ}}, (16)

where β_{mq}=(ζ_{q}+ξₘ)(fₘλ/c+1). It may be convenient to express x_{q}(t) as a sum of is single frames

x_{q}(t)=Σₚ₌₀^{P-1}x_{q}^{p}(t) (17)

where

x_{q}^{p}(t)=Σₘ₌₀^{M-1}Σₗ₌₁^{L}αₗhₘ(t−τₗ−pτ)e^{j2πβ}^{_{mq}}^{θ}^{ₗ}e^{j2πf}^{ₗ}^{^{D}}^{_{pτ}} (18)

The disclosed subject matter may be utilized for the goal of estimating targets' range, azimuth and velocities, i.e. τₗ, θₗ and fₗ^{D} from low rate samples of x_{q}(t), and a small number M and Q of antennas.

In some exemplary embodiments, a special case of P=1 may apply, namely a unique pulse is transmitted by each transmit antenna. By utilizing the disclosed subject matter, the range-azimuth map can be recovered from Xamples in time and space, as described hereinafter.

The received signal x_{q}(t) at the q-th antenna may be limited to tε[0,τ] and thus can be represented by its Fourier series

$$\begin{matrix} {x}_{q} ( t ) = {\sum }_{k ∈ ℤ} {c}_{q} [ k ] {e}^{- j 2 π kt / τ} , t ∈ [ 0 , τ ] & ( 19 ) \\ where , for - \frac{NT}{2} \leq k \leq \frac{NT}{2} - 1 , with N = τ {B}_{h} , & \\ {c}_{q} [ k ] = \frac{1}{τ} {\int }_{0}^{τ} {x}_{q} ( t ) {e}^{- j 2 π kt / τ} dt = \frac{1}{τ} {\sum }_{m = 0}^{M - 1} {\sum }_{l = 1}^{L} {α}_{l} {e}^{j 2 {πβ}_{mq} {ϑ}_{l}} {e}^{- j \frac{2 π}{τ} k {τ}_{l}} {H}_{m} ( \frac{2 π}{τ} k ) . & ( 20 )\end{matrix}$$

In order to obtain the Fourier coefficients c_{q}[k] in (20) from low-rate samples of the received signal x_{q}(t), a sub-Nyquist sampling scheme may be used. For each received transmission, Xampling allows one to obtain an arbitrary set κ, comprised of K=|κ| frequency components from K point-wise samples of the received signal after appropriate analog preprocessing. Therefore, MK Fourier coefficients are acquired at each receiver from MK samples, with K coefficients per frequency band or transmission.

Once the Fourier coefficients c_{q}[k], for k Click are acquired, they may be separated into channels for each transmitter, by exploiting the fact that they do not overlap in frequency. Applying a matched filter, one may have

$${\tilde{c}}_{q , m} [ k ] = {c}_{q} [ k ] {H}_{m}^{*} ( \frac{2 π}{τ} k ) = \frac{1}{τ} {\vert {H}_{m} ( \frac{2 π}{τ} k ) \vert}^{2} {\sum }_{l = 1}^{L} {α}_{l} {e}^{j 2 {πβ}_{mq} {ϑ}_{l}} {e}^{- j \frac{2 π}{τ} k {τ}_{l}} . \qquad ( 21 )$$

Let

$${y}_{m , q} [ k ] = \frac{τ}{{\vert {H}_{0} ( \frac{2 π}{τ} k ) \vert}^{2}} {\tilde{c}}_{q , m} [ k + {f}_{m} τ ]$$

the normalized and aligned Fourier coefficients of the channel between the m-th transmitter and q-th receiver. Then,

$${y}_{m , q} [ k ] = {\sum }_{l = 1}^{L} {α}_{l} {e}^{j 2 {πβ}_{mq} {ϑ}_{l}} {e}^{- j \frac{2 π}{τ} k {τ}_{l}} {e}^{j π {f}_{m} {τ}_{l}} \\ for - \frac{N}{2} \leq k \leq - \frac{N}{2} - 1. \qquad ( 22 )$$

The disclosed subject matter may be utilized for the goal of recovering the targets' parameters τₗ and θₗ from y_{m,q}[k].

In some exemplary embodiments, the disclosed subject matter may be limited to the Nyquist grid with respect to the total bandwidth TBₕ, similarly as in traditional MIMO, so that

$${τ}_{l} = \frac{τ}{TN} {S}_{l} ,$$

where sₗ may be an integer satisfying 0≦sₗ≦TN−1 and

$${ϑ}_{l} = - 1 + \frac{2}{TR} {r}_{l} ,$$

where rₗ may be an integer satisfying 0≦rₗ≦TR−1. Let Y^{m} denote the K×Q matrix with q-th column given by y_{m,q}[k], kεK. Y^{m} may be written as

Y^{m}=A^{m}X(B^{m})^{H} (23)

where A^{m} may denote a K×TN matrix whose (k,n)th element is e

$${ }^{- j \frac{2 π}{TN} {κ}_{k} n} \qquad {e}^{- j 2 π \frac{{f}_{m} n}{{B}_{h} T}}$$

with κₖ the k-th element in κ, B^{m} may denote a Q×TR matrix with (q,p)th element

$${e}^{- j 2 {πβ}_{mq}} ( - 1 + \frac{2}{TR} p )$$

and (·)^{H} denotes the Hermitian operator. The matrix X may be a TN×TR matrix that contains the values αₗ at the L indices (sₗ, rₗ).

The disclosed subject matter may be utilized for the goal of recovering X from the measurement matrices Y^{m}, 0≦m≦M−1. The time and spatial resolution induced by X may be

$$\frac{τ}{TN} = \frac{1}{{B}_{h}} , and \frac{2}{TR} ,$$

as in classic CDMA processing. In some exemplary embodiments, X may be recovered from Nyquist rate samples on a full virtual array, which is equivalent to full rank matrices A and B, where

A=[A⁰^{^{T}}A¹^{^{T}} . . . A^{M-1}^{^{T}}]^{T} (24)

and

B=[B⁰^{^{T}}B¹^{^{T}} . . . B^{M-1}^{^{T}}]^{T} (25)

It will be appreciated by a person skilled in the art that in some exemplary embodiments it may be required that min{spark(A), spark(B)}>2L, where the design parameters fₘ, ξₘ, ζ_{q},|κ| may be chosen accordingly.

To recover the sparse matrix X from the set of equations (27), for all 0≦m≦M−1, it may be required to solve the following optimization problem

min∥X∥₀s.t.A^{m}X(B^{m})^{T}=Y^{m},0≦m≦M−1 (26)

To this end, an extension of matrix OMP may be used, to solve (26), as shown in Algorithm 1. In the algorithm description, vec(Y) is defined as follows

$$vec ( Y ) {=}^{△} [ \begin{matrix}vec ( {Y}^{0} ) \\ vec ( {Y}^{1} ) \\ ⋮ \\ vec ( {Y}^{M - 1} )\end{matrix} ] = [ \begin{matrix}{\overline{B}}^{0} ⊗ {A}^{0} \\ {\overline{B}}^{1} ⊗ {A}^{1} \\ ⋮ \\ {\overline{B}}^{M - 1} ⊗ {A}^{M - 1}\end{matrix} ] vec ( X ) , \qquad ( 27 )$$

where vec(X) is a column vector that vectorizes the matrix X by stacking its columns, \textcircled{×} denotes the Kronecker product, and B̅ is the conjugate of B.
Also, dₜ(l)=[(dₜ⁰(l))^{T} . . . (dₜ^{M-1}(l))^{T}]^{T} where dₜ^{m}(l)=vec(a_{Λ}_{ₜ}_{(l,1)}^{m}((b̅^{m})_{Λ}_{ₜ}_{(l,2)}^{T})^{T}) with Λₜ(l,i), the (l,i)th element in the index set Λₜ at the t-th iteration, and Dₜ=[dₜ(1) . . . dₜ(t)], where aⱼ^{m} the j-th column of the matrix A^{m} and it follows that (b^{m})ⱼ^{T} denotes j-th row of the matrix B^{m}.
Once X is recovered, the delays and azimuths may be estimated as

$$\begin{matrix}{\hat{τ}}_{l} = \frac{τ}{TN} {Λ}_{L} ( l , 1 ) , & ( 28 ) \\ {\hat{ϑ}}_{l} = - 1 + \frac{2}{TR} {Λ}_{L} ( l , 2 ) . & ( 29 )\end{matrix}$$

```
ALGORITHM 1
Input:  Observation matrices Y^{m}, measurement matrices A^{m}, B^{m},
        for all 0 ≦ m ≦ M − 1
Output: Index set Λ containing the locations of the non zero indices of X,
      estimate for sparse matrix \hat{X}
1: Initialization: residual R₀^{m} = Y^{m}, index set Λ₀ = φ, t = 1
2: Project residual onto measurement matrices:
                      Ψ = A^{H}RB
  where A and B are defined in (24) and (25), respectively,
  and R = diag([Rₜ₋₁⁰ . . . Rₜ₋₁^{M-1}]) is block diagonal
3: Find the two indices λₜ = [λₜ(1) λₜ(2)] such that
                      [λₜ(1) λₜ(2)] = arg max_{i,j} |Ψ_{i,j}|
4: Augment index set Λₜ = Λₜ ∪ {λₜ}
5: Find the new signal estimate
                  \hat{α} = [\hat{α}₁ . . . \hat{α}ₜ]^{T} = (Dₜ^{T}Dₜ)⁻¹Dₜ^{T}vec(Y)
6: Compute new residual
                    ${R}_{t}^{m} = {Y}^{m} - {\sum }_{l = 1}^{t} \hat{{α}_{l}} {{a}_{{Λ}_{t} ( l , 1 )}^{m} ( {\overline{b}}_{{Λ}_{t} ( l , 2 )}^{m} )}^{T}$
7: If t < L, increment t and return to step 2, otherwise stop
8: Estimate support set \hat{Λ} = Λ_{L}
9: Estimate matrix \hat{X}: (Λ_{L}(l, 1), Λ_{L}(l, 2))-th component of \hat{X} is given by
  \hat{α}₁ for l = 1, . . . , L while rest of the elements are zero
```

It will be appreciated that, similarly, other CS recovery algorithms, such as FISTA, can be extended to our setting, namely to solve (26).

In some exemplary embodiments, the disclosed subject matter may be utilized for solving range-azimuth-Doppler recovery problems, by extending Xampling to multi pulses signals, as described hereinafter.

Similarly to the derivations described herein with respect to range-azimuth recovery, the p-th frame of the received signal at the q-th antenna, namely x_{q}^{p}(t), may be represented by its Fourier series

$$\begin{matrix}{x}_{q}^{p} ( t ) = {\sum }_{k ∈ ℤ} {c}_{q}^{p} [ k ] {e}^{- j 2 π kt / τ} , t ∈ [ p τ , ( p + 1 ) τ ] , & ( 30 ) \\ where , for & \\ - \frac{NT}{2} \leq k \leq \frac{NT}{2} - 1 , & \\ with & \\ N = {τB}_{h} , & \\ {c}_{q}^{p} [ k ] = \frac{1}{τ} {\sum }_{m = 0}^{M - 1} {\sum }_{l = 1}^{L} {α}_{l} {e}^{j 2 π {β}_{mq} {ϑ}_{l}} {e}^{- j \frac{2 π}{τ} {kτ}_{l}} {e}^{j 2 π {f}_{l}^{D} p τ} {H}_{m} ( \frac{2 π}{τ} k ) . & ( 31 )\end{matrix}$$

After separation to channels by matched filtering, the normalized and aligned Fourier coefficients

$${y}_{m , q}^{p} [ k ] = \frac{τ}{{\vert {H}_{0} ( \frac{2 π}{τ} k ) \vert}^{2}} {\tilde{c}}_{q , m}^{p} [ k + {f}_{m} τ ] , with {\tilde{c}}_{q , m}^{p} [ k ] = {\tilde{c}}_{q}^{p} [ k ] {H}_{m}^{*} ( \frac{2 π}{τ} k ) ,$$

may be given by

$${y}_{m , q}^{p} [ k ] = {\sum }_{l = 1}^{L} {α}_{l} {e}^{j 2 π {β}_{mq} {ϑ}_{l}} {e}^{- j \frac{2 π }{τ} k {τ}_{l}} {e}^{j 2 π {f}_{m} {τ}_{l}} {e}^{j 2 π {f}_{l}^{D} pτ} , for - \frac{N}{2} \leq k \leq \frac{N}{2} - 1. \qquad ( 32 )$$

The Fourier coefficients y_{m,q}^{p}[k] of the frames of each channel (32) are identical to (22) except for the additional Doppler term e^{j2πf}^{ₗ}^{^{D}}^{pτ}.

In some exemplary embodiments, the time delays, azimuths and Doppler frequencies may be assumed to lie on a grid, such that

$${τ}_{l} = \frac{τ}{TN} {S}_{l} , {ϑ}_{l} = - 1 + \frac{2}{TR} {r}_{l} , and {f}_{l}^{D} = - \frac{1}{2 τ} + \frac{1}{P τ} {u}_{l} ,$$

where sₗ, rₗ, and uₗ may be integers satisfying 0≦sₗ≦TN−1, 0≦rₗ≦TR−1 and 0≦uₗ≦P−1, respectively. Let Z^{m} be the KQ×P matrix with q-th column given by the vertical concatenation of y_{m,q}^{p}[k], kεK, for 0≦q≦Q−1. We can then write Z^{m} as

Z^{m}=(B̅^{m} [symbol] A^{m})X_{D}F^{H}, (33)

where F denotes the P×P Fourier matrix, the K×TN matrix Am and the Q×TR matrix B^{m} may be defined similarly as in (23), and the matrix X_{D} may be a T²NR×P matrix that contains the values αₗ at the L indices (rₗTN+sₗ, uₗ).

The disclosed subject matter may be utilized for the goal of recovering X_{D} from the measurement matrices Z^{m}, 0≦m≦M−1. The time, spatial and frequency resolution stipulated by X_{D} may be

$$\frac{1}{{TB}_{h}} , \frac{2}{TR} and \frac{1}{P τ}$$

respectively.

In some exemplary embodiments, Doppler focusing may be applied to recover jointly the range, azimuth and Doppler frequency of the targets, in accordance with the disclosed subject matter. Once the Fourier coefficients (32) are acquired and processed, Doppler focusing may be performed for a specific frequency ν, that is

$${Φ}_{m , q}^{v} [ k ] = {\sum }_{p = 0}^{P - 1} {y}_{m , q}^{p} [ k ] {e}^{- j 2 π vp τ} = {\sum }_{l = 1}^{L} {α}_{l} {e}^{j 2 π {β}_{mq} {ϑ}_{l}} {e}^{- j \frac{2 π}{τ} ( k + {f}_{m} τ )} {τ}_{l} {\sum }_{p = 0}^{P - 1} {e}^{j 2 π ( {f}_{l}^{D} - v ) p τ} , for - \frac{N}{2} \leq k \leq \frac{N}{2} - 1. \qquad ( 34 )$$

In some exemplary embodiments, it may hold that

$${\sum }_{p = 0}^{P - 1} {e}^{j2 π ( {f}_{1}^{D} - v ) p τ} ≅ \{ \begin{matrix}P & \vert {f}_{l}^{D} - v \vert \leq \frac{1}{2 P τ} \\ 0 & otherwise\end{matrix} \qquad ( 35 )$$

Therefore, for each focused frequency ν, (33) may be reduced to (22) and the resulting CS problem to solve may be exactly as in (27), for 0≦m≦M−1. It will be appreciated by a person skilled in the art that Doppler focusing may increase the SNR by a factor of P. Algorithm 2 extends Algorithm 1 to solve (33) using Doppler focusing. It will be appreciated that step 1 can be performed using fast Fourier transform (FFT). In the description of Algorithm 2 herein, vec(Z) may be defined similarly to vec(Y) in (27), eₜ(l)=[(eₜ⁰(l))^{T} . . . (eₜ^{M-1}(l))^{T}]^{T}, where eₜ^{m}(l)=vec((B̅^{m} [symbol] A^{m})_{Λ}_{ₜ}_{(l,2)TN+Λ}_{ₜ}_{(l,1)}((F̅)_{Λ}_{ₜ}_{(l,3)}^{T})^{T}), with Λₜ(l, i) the (l,i)th element in the index set Λₜ at the t-th iteration, and Eₜ=[eₜ(l) . . . eₜ(l)]. Once X_{D} is recovered, the delays and azimuths may be given by (28) and (29), respectively and the Dopplers may be estimated as

$${\hat{f}}_{l}^{D} = - \frac{1}{2 τ} + \frac{1}{p τ} {Λ}_{L} ( l , 3 ) . \qquad ( 36 )$$

```
ALGORITHM 2
OMP for simultaneous sparse 3D recovery with focusing
Input:  Observation matrices Z^{(m,p)}, measurement matrices A^{(m,p)}, B^{(m,p)},
        for all 0 ≦ m ≦ M − 1 and 0 ≦ p ≦ P − 1
Output: Index set Λ containing the locations of the non zero indices of X,
      estimating for sparse matrix \hat{X}
1:  Perform Doppler focusing for 0 ≦ i ≦ TN and 0 ≦ j ≦ TR
                        ${Φ}_{i , j}^{( m , v )} = {\sum }_{p = 0}^{P - 1} {Z}_{i , j}^{( m , p )} {e}^{j 2 π vp τ}$
2:  Initialization: residual R₀^{(m,p)} = Φ^{(m,p)}, index set Λ₀ = φ, t = 1
3:  Project residual onto measurement matrices for 0 ≦ p ≦ P − 1:
                          Ψ^{p} = A^{H}R^{p}B
where A and B are defined in (24) and (25), respectively,
and R^{p} = diag([Rₜ₋₁^{(0,p)} . . . Rₜ₋₁^{(M-1,p)}]) is block diagonal
4:  Find the three indices λₜ = [λₜ(1) λₜ(2) λₜ(3)]
    such that [λₜ(1) λₜ(2) λₜ(3)] = arg max_{i,j,p}|Ψ_{i,j}^{p}|
5:  Augment index set Λₜ = Λₜ ∪ {λₜ}
6:  Find the new signal estimate
                    \hat{α} = [\hat{α}₁ . . . \hat{α}ₜ]^{T} = (Eₜ^{T}Eₜ)⁻¹Eₜ^{T}vec(Z)
7:  Compute new residual
                  ${R}_{t}^{( m , p )} = {Y}^{m} - {\sum }_{l = 1}^{t} {α}_{l} {e}^{j 2 π ( - \frac{1}{2} + \frac{{Λ}_{t} ( l , 3 )}{P} ) p} {{a}_{{Λ}_{t} ( l , 1 )}^{m} ( {\overline{b}}_{{Λ}_{t} ( l , 2 )}^{m} )}^{T}$
8:  If t < L, increment t and return to step 3, otherwise stop
9:  Estimate support set \hat{Λ} = Λ_{L}
10: Estimate matrix \hat{X}_{D}: (Λ_{L}(l, 2)TN + Λ_{L}(l, 1), Λ_{L}(l, 3))-th component of
    \hat{X}_{D} is given by \hat{α}₁ for l = 1, . . . , L while rest of the elements are zero
```

In some exemplary embodiments, the frequency bands left vacant in accordance with the disclosed subject matter, such as described with respect to FIGS. 4A-4B, can be exploited to increase the system's performance without expanding the total bandwidth of Bₜₒₜ=TBₕ, thus preserving assumption A3 (5) and A5 (8). Denote by y=T/M the compression ratio of the number of transmitters. In this configuration, which may be referred to in the present disclosure as multi-carrier sub-Nyquist MIMO radar, each transmit antenna may send pulses in each PRI. Each pulse may belong to a different frequency band and may be therefore mutually orthogonal, such that the total number of user bands may be MγBₕ=TBₕ. The i-th pulse of the p-th PRI may be transmitted at time iτ/γ+pτ, for 0≦i≦y and 0≦p≦P−1. The samples are then acquired and processed as described above. Besides increasing the detection performance as one skilled in the art would appreciate, this method may multiply the Doppler dynamic range by a factor of γ with the same Doppler resolution since the CPI, equal to Pτ, may be unchanged. Preserving the CPI may allow to preserve the stationary condition on the targets, that is assumptions A2, A3 (5) and A4 may still be valid.

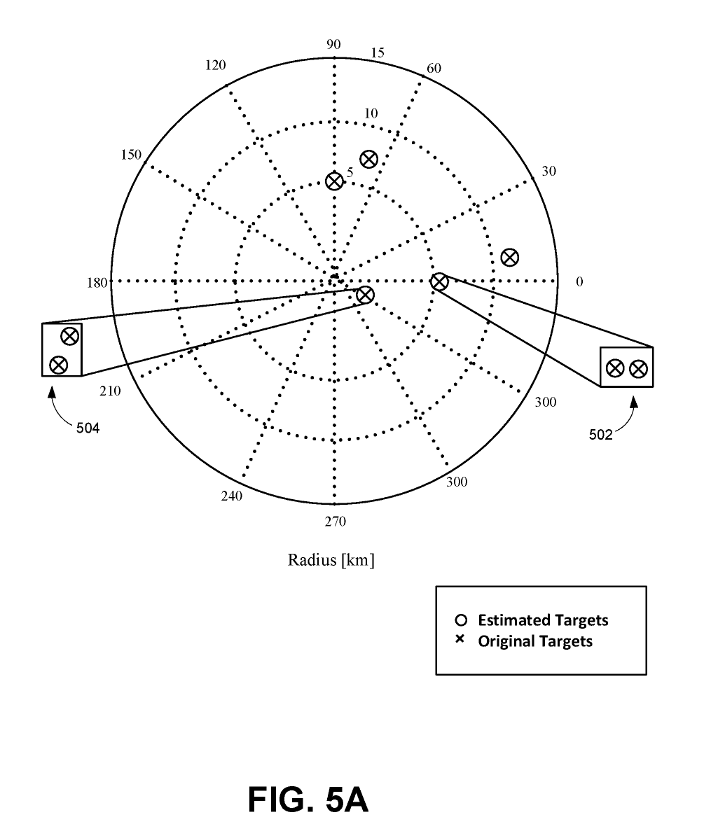

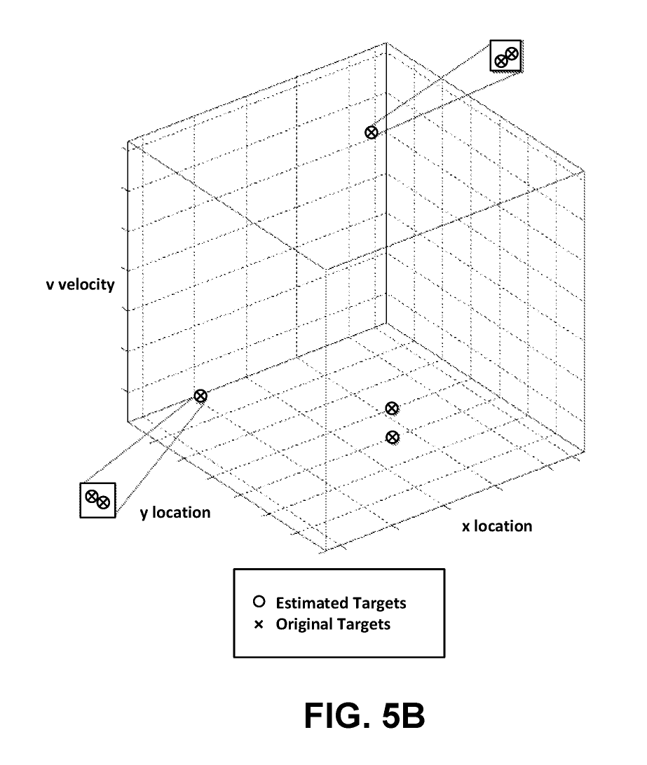

Referring now to FIGS. 5A-5B showing schematic illustrations of 2D and 3D target recovery in predefined grid, in accordance with some exemplary embodiments of the disclosed subject matter.

FIG. 5A shows the sparse target scene on a range-azimuth map, where each real target is displayed with its estimated location. As shown in FIG. 5A, targets with at a same azimuth with slight difference in their respective ranges, such as the target pair denoted 502, may still be identified and recovered with accuracy. Similarly, targets at a same range with slight difference in their respective azimuths, such as the target pair denoted 504, may also be effectively detected.

FIG. 5B demonstrates range-azimuth-Doppler recovery and shows the location and velocity of L=6 targets, including a couple of targets with close ranges, a couple with close azimuths and another couple with close velocities. For convenience purposes, the range and azimuth are converted to 2-dimensional x and y locations.

It will be appreciated that, while some exemplary embodiments of the disclosed subject matter are described and illustrated herein with respect to recovery of target parameters assumed to lie on a predefined grid, such as exemplified in FIGS. 5A-5B, it is not meant however to be limited in such manner and may be applied also in other scenarios as well, e.g. where recovery may be performed in an arbitrary resolution level.

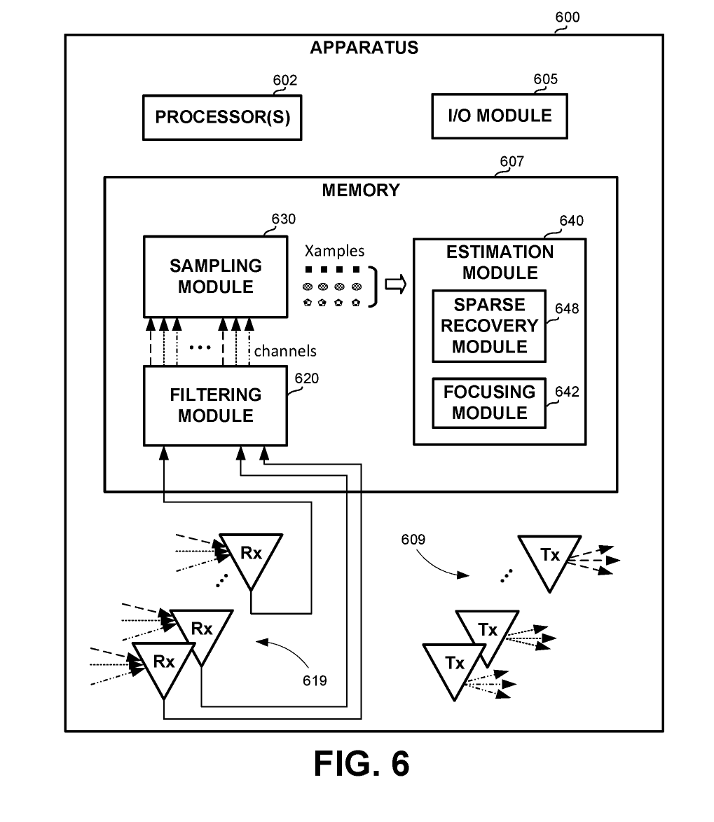

Referring now to FIG. 6 showing a block diagram of an apparatus, in accordance with some exemplary embodiments of the disclosed subject matter. An Apparatus 600 may be configured to support parallel user interaction with a real world physical system and a digital representation thereof, in accordance with the disclosed subject matter.

In some exemplary embodiments, Apparatus 600 may comprise one or more Processor(s) 602. Processor 602 may be a Central Processing Unit (CPU), a microprocessor, an electronic circuit, an Integrated Circuit (IC) or the like. Processor 602 may be utilized to perform computations required by Apparatus 600 or any of it subcomponents.

In some exemplary embodiments of the disclosed subject matter, Apparatus 600 may comprise an Input/Output (I/O) Module 605. I/O Module 605 may be utilized to provide an output to and receive input from a user, such as, for example display target recovery results, get design parameters configurations, or the like.

In some exemplary embodiments, Apparatus 600 may comprise a Memory 607.

Memory 607 may be a hard disk drive, a Flash disk, a Random Access Memory (RAM), a memory chip, or the like. In some exemplary embodiments, Memory 607 may retain program code operative to cause Processor 602 to perform acts associated with any of the subcomponents of Apparatus 600. In particular, Memory 607 may be utilized for storage of respective CS dictionary matrices conforming to MIMO configurations used, e.g., Nyquist or sub-Nyquist sampling rate, carrier frequencies and waveform bandwidth used, locations of transmit and receive antennas, size of aperture, and the like.

In some exemplary embodiments, Apparatus 600 may comprise or be coupled to a Transmitters (Tx) Array 609 having a plurality of radiating elements, also referred to as transmit antennas, configured to transmit a plurality of signals towards a target scene. Each of the radiating elements in Tx Array 609 may be configured to transmit a different signal or set of pulse signals, such that the plurality of signals are orthogonal. In some exemplary embodiments, the transmitted signals of Tx Array 609 may be distributed over a frequency range that is wider than the superposition thereof and have non-overlapping bandwidths.

Similarly, Apparatus 600 may comprise or be in communication with a Receivers (Rx) Array 619 having a plurality of receiving elements, i.e. receive antennas, configured to receive signals backscatters from a target scene, such as the signals transmitted by Tx Array 609. The radiating and receiving elements in Tx Array 609 and Rx Array 619 may be deployed in ULA structure. Additionally or alternatively, the total number of radiating and receiving elements in Tx Array 609 and Rx Array 619 may be smaller than a number thereof in a corresponding Nyquist MIMO array configuration. In some further exemplary embodiments, locations of the plurality of radiating and receiving elements in Tx Array 609 and Rx Array 619 may be chosen uniformly at random from locations of phased array receivers in a corresponding virtual ULA.

Filtering Module 620 may be configured to filter each of the signals received at Rx Array 619 and separate each such signal to a corresponding channel defined by a pair of transmit and receive antennas. Filtering Module 620 may apply matched filters for each of the plurality of transmitted signals, based on carrier frequency and waveform thereof, which may be predetermined or obtained during configuration of Tx Array 609.

Sampling Module 630 may be configured to sample each of the filtered signals obtained by Filtering Module 620 to obtain a set of samples for digital processing. In some exemplary embodiments, Sampling Module 630 may be configured to sample the filtered signals at a sub-Nyquist rate and obtain therefrom a set of Fourier coefficients, also referred to as Xamples.

Estimating Module 640 may be configured to recover positional parameters of at least one target present in the target scene, such as range, azimuth, Doppler frequency, or the like, as well as any combinations thereof. In some exemplary embodiments, Estimating Module 640 may utilize a Focusing Module 642 for performing Doppler focusing on the samples obtained by Sampling Module 630. Estimating Module 640 may apply on the samples a Sparse Recovery Module 648 configured for recovering a sparse matrix by solving a system of matrix equations, e.g. by performing 2D or 3D sparse matrix recovery, such as in Algorithm 1 or Algorithm 2 as described herein. Estimating Module 640 may estimate range, azimuth, and optionally Doppler frequency, where applicable, based on the sparse matrix recovered by Sparse Recovery Module 648, for each of the one or more targets detected. Sparse Recovery Module 648 may be adapted to recover the sparse matrix from the set of equations regardless of whether they are underdetermined or not, i.e. whether they are CS or Nyquist matrix systems.

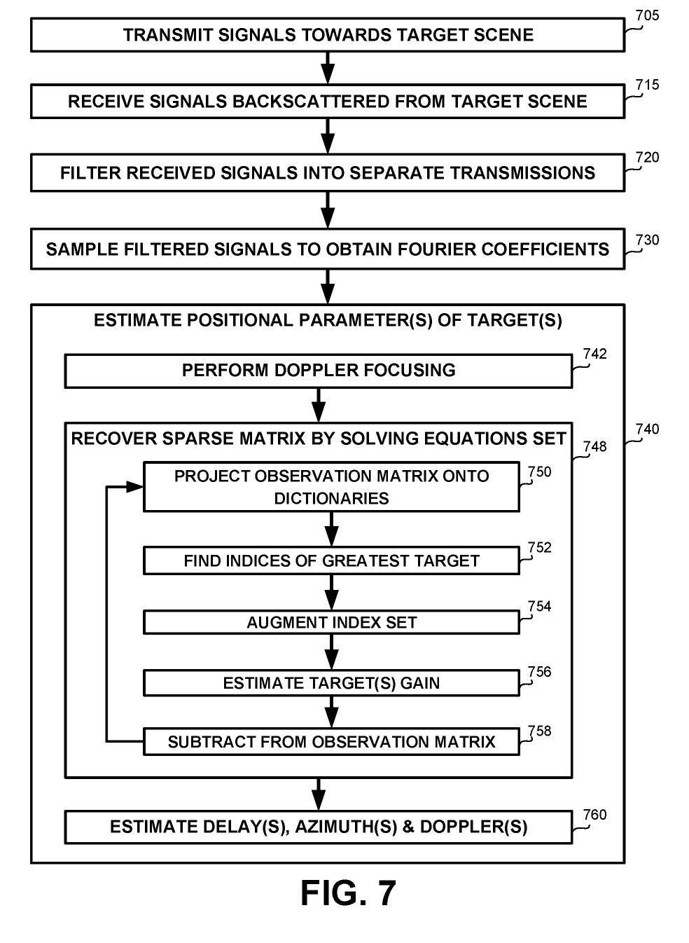

Referring now to FIG. 7 showing flowchart diagram of a method, in accordance with some exemplary embodiments of the disclosed subject matter.

On Step 705, a plurality of signals may be transmitted toward a target scene by a plurality of distributed radiating elements deployed in an array of a collocated MIMO radar system, similarly as Tx Array 609 of FIG. 6 and the transmissions performed thereby. In some exemplary embodiments, the transmitted signals may be spatially compressed with respect to a corresponding Nyquist MIMO array configuration of a same aperture at which the radiating elements are deployed. Additionally or alternatively, one or more vacant frequency bands may be left in the overall range of the transmissions. In some exemplary embodiments, each of the transmitted signals may comprise a train of pulses in order to allow velocity detection.

On Step 715, a plurality of signals backscattered from the target scene may be received by an array of a plurality of distributed receiving elements in the collocated MIMO radar, similarly as Rx Array 619 of FIG. 6.

On Step 720, the signals received on Step 715 at each of the distributed receiving elements of the MIMO may be filtered into separate channels corresponding to the signals transmitted on Step 705, similarly as performed by Filtering Module 620 of FIG. 6.

On Step 730, the filtered signals as obtained on Step 720 for each of the separate channels, as defined by pairs of transmit and receive elements in the respective arrays of the MIMO radar, may be sampled to obtain a discrete set of samples to be processed digitally, similarly as performed by Sampling Module 630 of FIG. 6. In some exemplary embodiments, the sampling may be performed at a sub-Nyquist rate, where a set of Fourier coefficients of an arbitrary size may be thereby obtained.

On Step 740, one or more positional parameters of one or more targets may be estimated by processing the set of samples obtained on Step 730, similarly as performed by Estimating Module 640 of FIG. 6. In some exemplary embodiments, Doppler focusing may be performed on Step 742 to allow recovery of the one or more targets' Doppler frequencies, similarly as performed by Focusing Module 642 of FIG. 6. The estimation may be performed using a process for sparse matrix recovery by solving a set of matrix equations on Step 748, similarly to the operation of Sparse Recovery Module 648 of FIG. 6. In some exemplary embodiments, the sparse recovery process may be an OMP for simultaneous sparse 2D or 3D recovery, as in Algorithm 1 or Algorithm 2 disclosed herein. For example, on Step 750, an observation matrix containing the samples obtained on Step 730 may be projected onto dictionary matrices containing hypothesized values for the positional parameters to be estimated. On Step 752, a tuple of indices of the greatest element in the projected observation matrix may be found. On Step 754, an index set of non-zero elements in the sparse matrix being recovered may be augmented by the tuple of indices found on Step 752. On Step 756, estimation of gain for a number of targets per the count of iterations may be performed simultaneously. On Step 758, based on the estimated gain obtained on Step 756 and dictionary values corresponding to the indices tuple obtained on Step 752, an appropriate differential may be subtracted from the observation matrix. Steps 750 to 758 may be repeated until a stopping criterion is met, e.g. once the count of iterations performed reaches the number of known targets, or when the residual energy in the observation matrix drops below a threshold level that may be attributed to mostly noise, or the like.

On Step 760, delays, azimuths and optionally Doppler frequencies, where applicable, may be estimated using the sparse matrix recovered on Step 748, similarly as performed by Estimating Module 640 of FIG. 6.

It will be appreciated by a person skilled in the art, that the minimal number of channels required for perfect recovery of L targets in noiseless settings may be MQ≧2L with a minimal number of MK≧2L samples per receiver, as well as for perfect recovery of X with L targets under the grid assumption, where M<T and Q<R are the number of transmit and receive antennas in the spatially compressed MIMO array, and K is number of the time compressed (i.e. sub-Nyquist rate) samples. Similarly, the minimal number of channels required for perfect recovery of L targets in noiseless settings, as well as for perfect recovery of X_{D} with L targets under the grid assumption, may be MQ≧2L with a minimal number of MK≧2L samples per receiver and P≧2L pulses per transmitter. Formal proofs, as well as simulation results and performance analysis are found in: D. Cohen, D. Cohen, Y. C. Eldar, A. M. Haimovich, “SUMMeR: Sub-Nyquist MIMO Radar.” arXiv preprint arXiv:1608.07799 (2016), hereby incorporated by reference in its entirety without giving rise to disavowment.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A radar system comprising:
a transmitter comprising an array of distributed radiating elements configured to transmit a plurality of signals towards a target scene;
a receiver comprising an array of distributed receiving elements configured to receive signals backscattered from the target scene;
a sampling module configured to sample the signals received by said receiver at sub-Nyquist rate to obtain a set of Fourier coefficients for each signal of the plurality of signals transmitted; and
a hardware processor configured to recover from the set of Fourier coefficients at least one position parameter for one or more targets within the target scene.

2. The radar system of claim 1, wherein the total number of radiating and receiving elements in the arrays is smaller than a number thereof in a corresponding Nyquist array configuration with a same aperture over which the arrays are distributed.

3. The radar system of claim 2, wherein locations of radiating and receiving elements are chosen uniformly at random from a virtual corresponding array configuration with the same aperture.

4. The radar system of claim 1, wherein the one or more position parameters are selected from the group consisting of: a range; an azimuth; a Doppler frequency; and any combination thereof.

5. The radar system of claim 1, wherein the hardware processor is configured to perform simultaneous processing of all sets of Fourier coefficients corresponding to channels defined by pairs of transmitters and receivers from each of the arrays.

6. A radar system comprising:
a transmitter comprising an array of distributed radiating elements configured to transmit a plurality of signals towards a target scene, wherein the plurality of signals having carrier frequencies that are distributed over a wide band and waveforms having a narrow bandwidth for each single transmission with respect to an effective sampling rate thereof, wherein the plurality of signals transmitted, when accumulated, do not occupy an entire frequency range of the wide band over which they are distributed;
a receiver comprising an array of distributed receiving elements configured to receive signals backscattered from the target scene;
a sampling module configured to sample the signals received by said receiver; and
a hardware processor configured to recover from samples sampled by said sampling module at least one position parameter for one or more targets within the target scene.

7. The radar system of claim 6, wherein the sampling module is further configured to sample the signals received by said receiver at sub-Nyquist rate to obtain a set of Fourier coefficients for each signal of the plurality of signals transmitted, wherein the hardware processor is configured to recover at least one position parameter from the set of Fourier coefficients.

8. The radar system of claim 6, wherein the total number of radiating and receiving elements in the arrays is smaller than a number thereof in a corresponding Nyquist array configuration with a same aperture over which the arrays are distributed.

9. The radar system of claim 8, wherein locations of radiating and receiving elements are chosen uniformly at random from a virtual corresponding array configuration with the same aperture.

10. The radar system of claim 6, wherein the one or more position parameters are selected from the group consisting of: a range; an azimuth; a Doppler frequency; and any combination thereof.

11. The radar system of claim 6, wherein the hardware processor is configured to perform simultaneous processing of a plurality of samples corresponding to all channels defined by pairs of transmitters and receivers from each of the arrays.

12. A method comprising:
obtaining a set of samples of a plurality of signals transmitted from an array of distributed radiating elements towards a target scene and received at an array of distributed receiving elements as reflected back from the target scene; and
estimating gain and position parameters of at least one target contained in the target scene,
wherein said estimating comprises applying a process for solving a set of matrix equations to recover a sparse matrix, wherein input for the process comprises: an observation matrix of samples from the set that correspond to respective signals received at each of the receiving elements for each of the signals transmitted, and measurement matrices of grid coordinates conforming to hypothesized position parameters whereby a dictionary of possible values for each of the position parameters is defined;
wherein estimated gain and position parameters for each of the at least one target are provided by respective values and indices of non-zero entries of the sparse matrix recovered by the process;
wherein the process is adapted for simultaneously processing of all channels defined by pairs of transmitters and receivers from each of the arrays.

13. The method of claim 12, wherein the process comprises iteratively performing, until a stopping condition is fulfilled, the steps of: projecting the observation matrix onto the dictionaries of position parameters defined by the measurement matrices to obtain a projected observation matrix; determining a tuple of indices of a maximal element in the projected observation matrix; augmenting an index set containing all tuples of indices determined in all iterations; estimating gain of a number of targets corresponding to a number of iterations performed; subtracting from the observation matrix for each of the number of targets a value obtained based on the measurement matrices, tuple of indices determined and gain estimated for each target; and repeating said projecting, determining, augmenting, estimating and subtracting.

14. The method of claim 13, further comprising performing a step of Doppler focusing, wherein the plurality of signals transmitted comprise multiple pulses for each transmitter in the array.

15. The method of claim 12, wherein the one or more position parameters are selected from the group consisting of: a range; an azimuth; a Doppler frequency; and any combination thereof.

16. The method of claim 12, further comprising applying matched filters on signals received at each receiver to separate each received signal into the plurality of signals transmitted.

17. The method of claim 12, wherein spatial compression is performed by having a total number of radiating and receiving elements in the arrays that is smaller than a number thereof in a corresponding Nyquist array configuration with a same aperture over which the arrays are distributed.

18. The method of claim 12, wherein the set of samples is obtained by sampling the signals received at each of the receiving elements at a sub-Nyquist rate, whereby a set of Fourier coefficients for each signal of the plurality of signals transmitted is obtained.

19. The method of claim 12, wherein the plurality of signals transmitted are assigned carrier frequencies that are distributed over a wide band and waveforms having a narrow bandwidth for each single transmission with respect to an effective sampling rate thereof, wherein the plurality of signals transmitted, when accumulated, do not occupy an entire frequency range of the wide band over which they are distributed.

20. An apparatus having a processor, the processor being adapted to perform the steps of the method of claim 12.
